(19) United States
(12) Patent Application Publication
(10) Pub. No.: US 2017/0015692 A1
(43) Pub. Date: Jan. 19, 2017

(54) PROCESS FOR TREATING BLACK LIQUOR

(71) Applicant: REN FUEL K2B AB, Stockholm (SE)

(72) Inventors: Joseph SAMEC, Spanga (SE); Christopher CARRICK, Stockholm (SE)

(73) Assignee: REN FUEL K2B AB, Stockholm (SE)

(21) Appl. No.: 15/124,870

(22) PCT Filed: Feb. 26, 2015
(86) PCT No.: PCT/SE2015/050212

§ 371 Date: Sep. 9, 2016

(30) Foreign Application Priority Data
Mar. 12, 2014 (SE) 1450282-7
Jul. 3, 2014 (SE) 1450832-9

(51) Int. Cl. C07G 1/00; C08H 7/00; B01D 61/14; D21C 11/00

(52) U.S. Cl. CPC C07G 1/00; D21C 11/0007; C08H 6/00; B01D 61/145; B01D 61/142; B01D 2311/25; B01D 2317/022; B01D 2317/025

(57) ABSTRACT

The present invention relates to a method of membrane-filtrating a lignin containing composition in order to obtain a lignin fraction more suitable for further treatments. In particular it relates to treating a liquid lignin composition to obtain a lignin fraction having a desired molecular weight distribution by a membrane filtration. It comprises subjecting the liquid lignin composition to a first membrane filtration with a first filter cut-off adapted to remove species having a first molecular weight thereby providing a permeate with a molecular weight distribution defined by said cut-off. Then, the permeate from the first membrane filtration is; subjected to at least one further filtration step with a second filter cut-off, different from said first filter cut-off to provide a retentate (concentrate) with a molecular weight distribution defined by both the cut-off in the first filter the cut-off in said second filter. A dilution is performed on a desired lignin containing fraction at some point downstream of the first filtration unit. A lignin containing retentate (concentrate) is collected from the further ultrafiltration for further processing.

The invention relates to a process for extracting, purifying and concentrating lignin of improved quality from black liquor, for subsequent use in further processes such as catalytic processes.

### BACKGROUND OF THE INVENTION

Applicants have previously devised methods for treating lignin derived from black liquor to render it usable for subsequent processing by catalysis to provide a raw material for making fuel, see applicants published International patent application WO 2012/121659 (A1) unpublished International patent application PCT/SE2013/051045.

Lignin is a very complex material with a broad molecular size distribution, and it is desirable to provide a more homogeneous product with smaller fragments, i.e. wherein the lignin species have a lower molecular weight.

A process for improving the quality of lignosulfonate produced from red liquor is known from i.a. WO 2011/075060 A1 (Domsjö). The process comprises ultra-filtration in two steps with a first cut-off at 40-150 kDa (high cut-off) and a second cut-off at 1-20 kDa (low cut-off). The extracted lignosulfonate is then concentrated by e.g. evaporation of water. Thus, this process is not directed to lignin as such.

In an article “Concentration and purification of lignin in hardwood kraft pulping liquor by ultrafiltration and nanofiltration”, Jönsson et al, in chemical engineering research and design 86 (2008) 1271-1280, a process is described for extracting lignin from black liquor by ultrafiltration and nanofiltration. No dilution and no recirculation of process liquids are performed.

In an article “Ultrafiltration Nanofiltration” by Ricker, University of Washington, May 2005, obtainable online:

http://aigep.inp-toulouse.fr/en/protocoles:angoais/ufnf051_english.pdf
a process for obtaining lignin using ultrafiltration and nanofiltration is described. Dilution is performed on a fraction of recirculated process liquid, but the process is a batch process, which is not very efficient.

### SUMMARY OF THE INVENTION

In view of the need to provide higher quality lignin raw material, the inventors have designed a novel process based on membrane filtration (MF), which meets the objective of providing lignin with improved properties. In particular, the process results in a lignin material with molecular weight distribution in the range of approximately 0.2-15 kDa. Membrane filtration encompasses the notion of ultra-filtration, which is a variety of membrane filtration in which forces like pressure or concentration gradients leads to a separation through a semipermeable membrane. In lower ranges, i.e. below about 1 kDa one refers commonly to nano filtration, which also can be used in terms of reverse osmosis.

The novel process is defined in claim 1.

The main advantage with this process is that it provides a lignin fraction that is better suited for subsequent reductive treatment or functionalization. In particular the ash content, i.e. the residual boiler chemicals used in the paper mill/pulping plant, is reduced by virtue of the dilution performed in the process. Low ash content is important for use of the treated lignin material as a raw material in e.g. a refinery to produce fuels. Also, the chemicals used in the paper mill can be returned and reused, which is an economic advantage.

Furthermore, this process enables to withdraw a desired amount of lignin from the pulping process since the cut-off membranes and the membrane filtration operation can be designed for specific amount of lignin withdrawal compared to prior art processes such as the Lignoboost® process where all the precipitated lignin is extracted. In other words, since each pulping plant needs different amounts of lignin to produce energy, the present invention allows a withdrawal of lignin tailored to suit the specific plant. In the present invention the solubility or insolubility of lignin is not considered which can be a further improvement since this process provides a solution to extract a lignin with a desired molecular weight hence the process is not governed by its solubility properties but rather the molecular weight.

Preferred embodiments are defined in the dependent claims.

Further scope of applicability of the present invention will become apparent from the detailed description given hereinafter and the accompanying drawings which are given as an illustration only, and thus not to be considered as limiting on the present invention, and wherein.

### BRIEF DESCRIPTION OF THE FIGURES

FIG. 1 schematically illustrates the general process according to the invention;

FIG. 2 schematically illustrates an embodiment of an ultrafiltration process according to the present invention;

FIG. 3 schematically illustrates flows and contents of the flows from a real run

FIG. 4 is a graph showing flux through the filters over time; and

FIG. 5 illustrates schematically an embodiment with a first filter unit with a low filter cutoff and a second filter unit with a high filter cutoff.

### DETAILED DESCRIPTION OF PREFERRED EMBODIMENTS

Applicants have previously invented a method of producing a raw material for the oil industry by reducing lignin This process which is disclosed in International patent applications WO 2012/121659, SE1351508-5 and PCT/SE2013/051045 makes the lignin soluble in different kinds of oils, primarily in so called “gas oil”/“light gas oil” (LGO). The process is a catalytic reduction or an esterification of the lignin or a combination of both. Without being bound by theory it is believed that the reduction and functionalization of lignin works better with shorter lignin molecules (i.e. low molecular weight) and possibly also with lignin having a narrower molecular weight distribution, i.e. exhibiting lower polydispersity. Preferably the molecular weights are in the range 1.000-15.000 g/mol.

The present invention relates generally to a method of membrane filtration of liquid lignin containing compositions, such as black liquor, red or brown liquor or any other liquid composition containing lignin. The process further comprises recirculation of the liquid lignin composition and dilution of certain fractions containing lignin before subjecting to filtration, either in the incoming process flow to a filtration unit or in recirculated process liquid or both, at one or more points downstream of a first filtration step. Recirculation is preferably performed in a continuous loop, i.e. liquid is pumped from one point to another point in the system upstream thereof. If desired, dilution is thereby performed by injecting solvent, e.g. water into the recirculation pipes by suitable pumping means. This mode of recirculation is used in all embodiments of the process according to the present invention.

Membrane Filtration (MF) systems can either operate with cross-flow or dead-end flow. In dead-end filtration the flow of the feed solution is perpendicular to the membrane surface. On the other hand, in cross flow systems the flow passes parallel to the membrane surface. Dead-end configurations are more suited to batch processes with low suspended solids as solids accumulate at the membrane surface therefore requiring frequent back flushes and cleaning to maintain high flux. Cross-flow configurations are preferred in continuous operations since solids can continuously be flushed from the membrane surface resulting in a higher flux through the pores in the membrane.

For the purpose of this application the term “membrane filtration” shall include both cross-flow and dead-end flow modes by the use of porous membranes or filters.

In its most general embodiment the process according to the invention comprises subjecting a liquid lignin containing composition, e.g. black liquor, to a first membrane filtration with a first filter cut-off adapted to separate species in said liquid lignin containing composition in fractions thereby providing a permeate and a retentate having respective molecular weight distributions defined by said cut-off; subjecting either the retentate or the permeate from the first membrane filtration to at least one further ultrafiltration step with a second filter cut-off different from said first filter cut-off to provide a retentate (concentrate) and a permeate having respective molecular weight distributions defined by both the cut-off in the first filter and the cut-off in said second filter; recirculation of a fraction of the liquid lignin composition from a filter unit, suitably the retentate, back to inflowing liquid; wherein a dilution is performed on a desired lignin containing fraction at some point downstream of the first filtration unit; and collecting a desired lignin containing fraction, i.e. a retentate (concentrate) or a permeate from the further membrane filtration for further processing.

In preferred embodiments further membrane filtration steps are performed subsequent to said first and second filtration steps.

Preferably, retentate from a filtration is recirculated, i.e. the retentate is fed back to the inflowing liquid to the filtration unit in question from which the retentate is taken. Recirculation can be performed in one or more of the filtration units.

Suitably, dilution is performed in either the incoming flow to a second or further filtration step or in recirculated retentate from any filtration unit or both. The dilution can be performed at one or more points downstream of the first unit. As discussed above the dilution can be performed by injecting solvent, e.g. water in the main pipe line for the flowing fraction in question by using appropriate pumping means. Such dilution can be performed in all embodiments disclosed herein.

Combinations of dilution and recirculation at different points are also possible.

In an embodiment of the process according to the present invention it comprises subjecting the liquid lignin composition to a first membrane filtration with a first filter cut-off adapted to separate out species having a molecular weight over a predetermined value thereby providing a permeate with a molecular weight distribution having an upper limit defined by said cut-off; subjecting the permeate from the first ultrafiltration to at least one further membrane filtration step with a second filter cut-off which is lower than the cut-off of the first filter to provide a retentate (concentrate) with a molecular weight distribution having an upper limit defined by the cut-off in the first filter and a lower limit defined by the cut-off in said second filter; recirculating the retentate from at least one of the further filtration steps to increase the concentration to a desired amount of lignin; wherein a dilution is performed on a desired lignin containing fraction at some point downstream of the first filtration unit; and collecting a lignin containing retentate (concentrate) from the further-membrane filtration for further processing.

Suitably, the first cutoff is in the range 5-20 kDa, preferably 10-15 kDa. The second cutoff value is suitably in the range 1-0.2 kDa, preferably about 1 kDa.

Suitably, the retentate from at least one filtration is recirculated back to the incoming liquid to the filtration unit in question, and the dilution is performed on the recirculated liquid, or in the alternative the dilution is performed on the inflowing liquid directly.

In a further embodiment the novel method comprises subjecting the liquid lignin composition to a first membrane filtration with a first filter cut-off adapted to separate out species having a molecular weight below a predetermined value thereby providing a retentate with a molecular weight distribution having a lower limit defined by said first cut-off; subjecting the retentate from the first membrane filtration to at least one further filtration step with a second filter cut-off which is higher than the cut-off of the first filter to provide a permeate with a molecular weight distribution having a lower limit defined by the cut-off in the first filter and an upper limit defined by the cut-off in said further filter; recirculating the retentate from at least one of the further filtration steps to increase the concentration to a desired amount of lignin; wherein a dilution is performed on a desired lignin containing fraction at some point downstream of the first filtration unit; and collecting a lignin containing retentate (concentrate) from the further ultra filtration for further processing.

Suitably, the first cutoff is in the range 1-0.2 kDa, preferably about 1 kDa. The second cutoff value is suitably in the range 5-20 kDa, preferably 10-15 kDa.

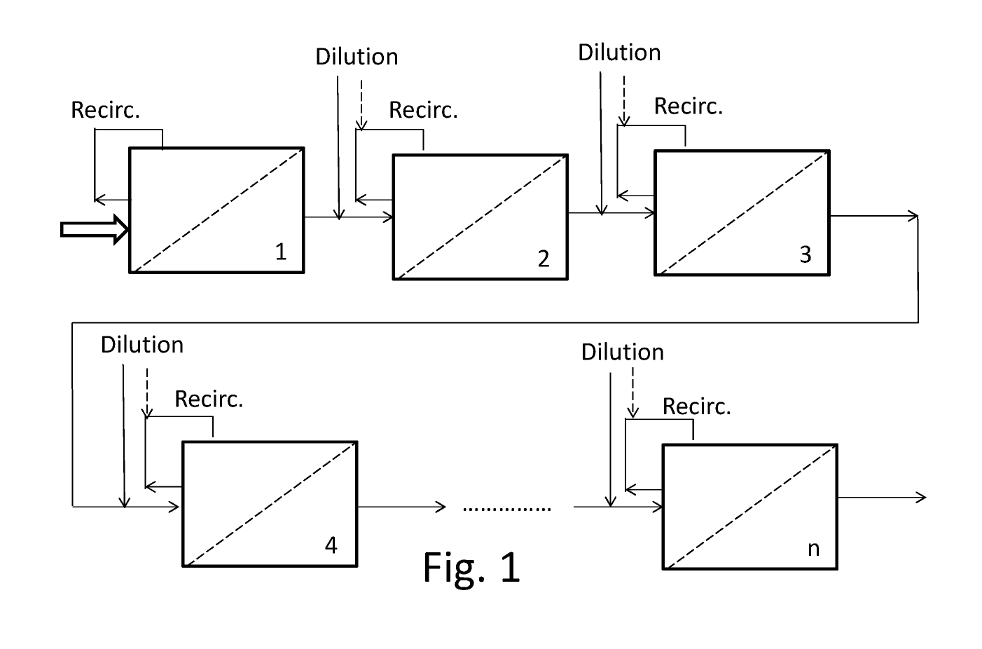

FIG. 1 illustrates the general aspect of the invention schematically.

A lignin containing composition, preferably boiler residues from a pulping plant, e.g. so called black liquor, is fed into a first filtration unit. The unit is provided with a cut-off filter such that a retentate and a permeate having the desired molecular weights are obtained. In embodiments of the process, described in further detail below, the cut-off can be either relatively high (5-20 kDa) or relatively low (1-5 kDa) depending on the process scheme.

In the former case, i.e. a first filter step with a high cut-off, the permeate is used for the further processing, and in the latter, i.e. a first filter step with a low cut-off, the retentate is used.

In FIG. 1 the arrows indicating outflowing liquid denotes both retentate and permeate, depending on which embodiment is considered.

The number of filtration steps is optional, as indicated there are n units in the set up in FIG. 1. From a practical point the number is suitably more than 2 units, preferably 3-5 units, and can be any of 2, 3, 4, 5, 6, 7, 8 or 9 or more units.

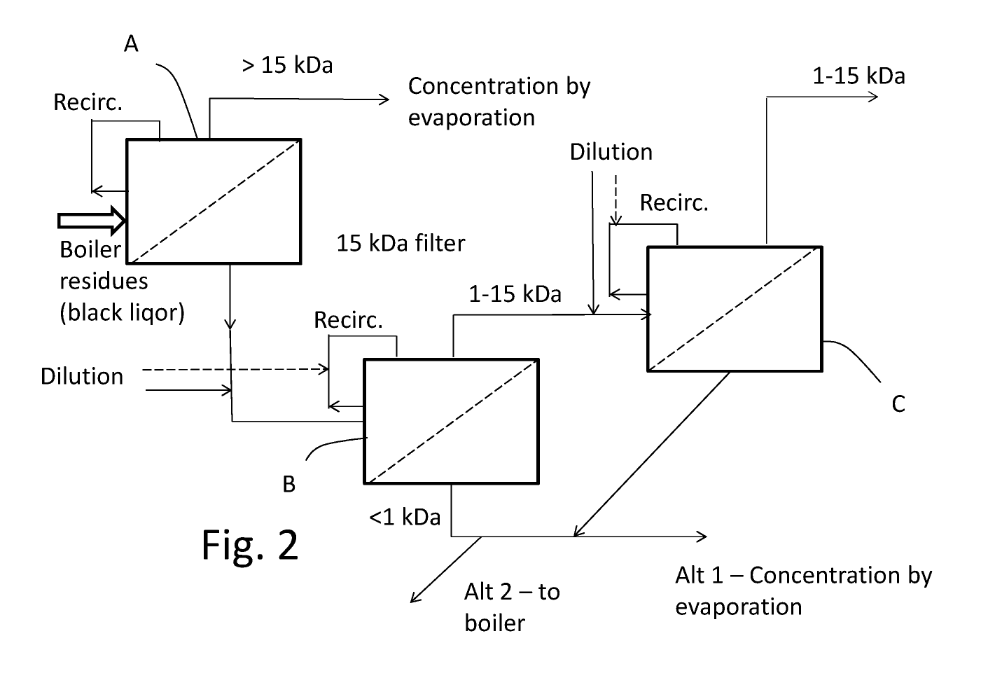

FIG. 2 schematically illustrates one embodiment of the novel process, based on membrane filtration, for treating a liquid lignin composition, for example black liquor, from the so called sulphate process (Kraft process) for making paper pulp.

The black liquor that may be fed into the described process contains lignin such as “Kraft lignin” of a broad molecular weight distribution (from a few hundred g/mol up to several hundreds of thousands g/mol).

Black liquor is an aqueous solution of lignin residues, hemicellulose, extractives, and inorganic chemicals used in the process. The black liquor comprises about 20% solids by weight of which 10% are inorganic and 10% are organic. The black liquor can however have considerably higher concentration of the dry solids since evaporation of the water from the black liquor is commonly used. The black liquor can have concentrations up to above 80% dry solids before burning. Normally the organics in black liquor are soaps (the soaps contain about 20% sodium), lignin and other organics. The organic matter in the black liquor is made up of water/alkali soluble degradation components from the wood.

In a first step the liquid containing lignin and possibly residues from a boiling process, e.g. inorganic matter such as salts, and cooking chemicals as indicated above is fed into an membrane filtration unit A having for example a cut-off of about 15 kDa to remove the large components. These large components could be further utilized for other purposes, such as burning, in which case the concentrate can be further concentrated by evaporation, or it can be reintroduced into the pulp mill. The high molecular fraction, i.e. >15 kDa is suitably recirculated in conventional manner in the first unit A to increase the concentration of the higher molecular fragments. Such recirculation can be performed either on batches of black liquor, or in a continuous process, which would require appropriate process control in terms of flow rates etc.

The cut-off for removing large components is not necessarily 15 kDa and can for example be 5 kDa or 10 kDa if the raw material has a different composition. It can also be larger, e.g. 20 kDa.

The retentate (concentrate) is removed and subjected to further processing (evaporation) to make it usable for e.g. burning.

The permeate now containing the desired lignin fraction, i.e. most of the lignin having a molecular weight of <15 kDa, is subsequently fed to a second step of ultra filtration in a second unit B which has a cut-off at 1 kDa to remove the small molecules, i.e. inorganic components and other small molecules that are not desirable. Also in this step, the high molecular fraction retentate (concentrate) is recirculated to increase the concentration or to a desired lignin amount. The low molecular fraction (permeate containing species <1 kDa) is returned to the Kraft process to primarily regenerate the cooking chemicals.

Dilution can be performed as indicated in the figure on the incoming flow to the second unit or on the recirculated liquid, or possibly on both, and also on subsequent units, as indicated in FIG. 1.

The concentrated fraction approximately 1-15 kDa, i.e. the retentate, is then possibly subjected to a third step of membrane filtration. Here the cut-off is suitably the same as in the second step so as to maintain the desired distribution of molecular weights of the lignin. In the figure this is shown as performed in a separate filtration unit C, but it is equally possible to utilize only two units, i.e. the first unit A and the second unit B, and the invention is not limited to any particular set-up of filtration units as long as the process is performed as described.

Also in this third step recirculation can be performed on a diluted concentrate stream, but dilution can also be performed on incoming liquid as previously described. That is, solvent (water) is added to the 1-15 kDa retentate (concentrate) from unit B (shown with a broke arrow), and the diluted high molecular weight fraction retentate in unit C is recirculated.

When the concentration of lignin or concentration of low molecular weight fractions in unit C has reached a predetermined value a lignin containing retentate is collected. The permeate of unit C may either be returned to the boiler (Alt 2) or concentrated by evaporation (Alt 1).

Suitably, the dilution is about 1:1 (concentrate:solvent, preferably water) such as to provide a reduction of the concentration to about 50%, but the dilution could range from 8:1 (reduction to about 90%) up to 1:2 (reduction to about 33%), or even 1:10 (reduction to 9%), maybe even 1:100 (reduction to about 1%) and the actual dilution usable will depend on circumstances at hand.

It should be noted that the cut-off values given above are only exemplary and could be varied within certain limits. In the first unit A the cut-off may be between 5-20 kDa, i.e. the cut off could be 5 kDa or any number up to 20 kDa, preferably at least 10 kDa, suitably 15 kDa, optionally 20 kDa. In the second unit B the cut-off may be 0.2-5 kDa, such as 3 kDa or lower, such as 0.3 or 0.4 kDa, suitably 1-2 kDa, preferably 1 kDa; and in the third unit C the cut-off can vary in the same ranges as in unit B, i.e. 0.2-5 kDa, such as 3 kDa or lower, such as 0.3 or 0.4 kDa, suitably 1-2 kDa, preferably 1 kDa. However, the invention is not limited to any of these ranges and depending on the composition of the black liquor and the requirement of the plant the cut-offs may be selected to have other values as well.

In another embodiment the method further comprises lowering the pH of the obtained filtrated fraction of lignin, i.e. lignin that has been membrane filtrated at least two times according to the present invention. The pH should be lowered so that the lignin precipitates. The precipitate is isolated preferably using filtration by adding a solvent such as methyl tert butyl ether.

In one embodiment a reduction or functionalization is performed on a desired lignin containing fraction at some point downstream of the first filtration unit. In one embodiment the retentate obtained after the second and/or third step, before or after recirculation may be reduced or functionalized. The reduction and functionalization may be performed using any suitable technique known in the art. In one embodiment the retentate is diluted with a solvent and a transition metal catalyst is added together with a hydrogen donor forming a mixture. The mixture is heated, preferably to a temperature of 200° C. or lower. The solvent is preferably a C1-C6 alcohol such as ethanol, propanol or iso-propanol.

The transition metal catalyst may be based on but not limited to palladium, ruthenium, nickel, iron, antimony or titanium. In one embodiment the catalyst is a solid phase catalyst.

The hydrogen donor may be any suitable compound that may act as a hydrogen donor, for example hydrogen, an alcohol or formic acid, preferably a C1-C6 alcohol. A non-limiting list of suitable alcohols is methanol (MeOH), ethanol (EtOH), propanol, iso-propanol (i-PrOH), glycerol, glycol, butanol, t-butanol (i-BuOH) or combinations thereof. In one embodiment the solvent is the hydrogen donor.

The main purpose of the functionalization is to provide an alkyl group on the lignin and the functionalization may be esterification, etherification or amidation. The esterification may be performed using an esterification reagent, or a fatty acid and an esterification reagent, and optionally a catalyst forming a mixture and heating said mixture. The esterification reagent may be selected from a carboxylic acid or an anhydride. The esterification catalyst may be an imidazole or pyridine. In one embodiment the fatty acid is a C6-C18 fatty acid, saturated or unsaturated. The esterification may be performed from 30° C., preferably 80° C. or higher, or 120° C. or higher, or 150° C. or higher. However the esterification may be performed at temperatures below 200° C. with good results.

In one embodiment the lignin of the retentate of the second step is reduced and the collected lignin containing retentate after the third step is functionalized. In one embodiment the lignin of the retentate of the second step is first reduced and then functionalized.

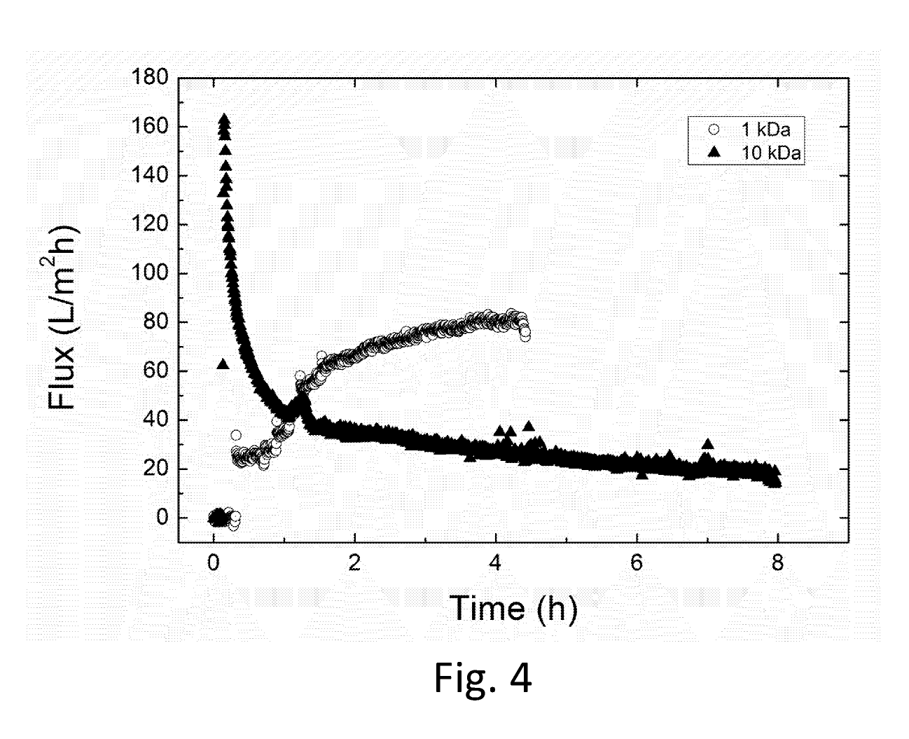

FIG. 4 shows a surprising effect, namely that the flux through the filter in Stage B, i.e. the low cut-off filter of 1 kDa, could be increased over time. In the first stage, i.e. cut-off 10 kDa, the flux drops rapidly during the initial 2 hours of the run.

Therefore, in a further embodiment the order of filtration can be reversed, i.e. the black liquor is subjected to the membrane filtration at a low cut-off as a first stage and the high cut-off at a second stage. In this embodiment the retentate from the first stage is passed to the second stage, and the permeate from the second stage is passed on to further processing, i.e. the opposite from the previously described embodiments.

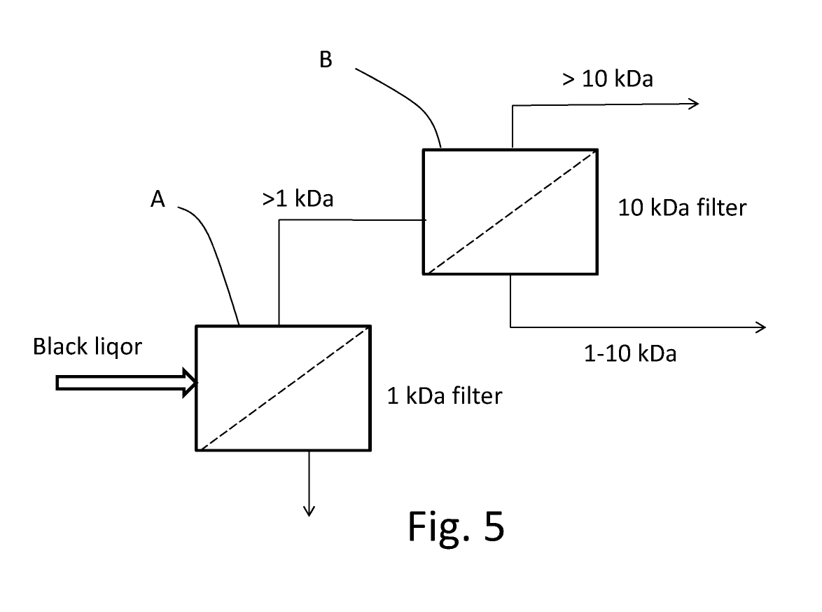

This embodiment is schematically shown in FIG. 5.

Of course the embodiment shown in FIG. 5 can also be supplemented with further filtration steps as shown in the general scheme in FIG. 1. Thus, as long as the sequence of filtration steps yields a lignin fraction having a desired molecular weight distribution, combinations of the above embodiments are within the inventive concept.

Also in this embodiment dilution and recirculation can of course be performed similar to the above described embodiments, although not explicitly shown in the figure. Also, there can be provided for more filtration steps subsequent to the second filtration, within the inventive concept, although only two steps are shown in FIG. 5.

The invention will be further illustrated by way if the following non-limiting examples.

### EXAMPLES

### Example 1

To membrane-filtrated lignin (double concentrated—prepared as above) 40 mg (1M in H2O) there was added MeOH (1 mL) and 52 mg of wet Raney nickel were added under argon atmosphere. The reaction was heated to 120° C. for 18 hours. Nickel was removed with magnet, and the reaction was neutralized with conc. HCl. The mixture was analyzed on GPC.

### Example 2

To membrane-filtrated lignin (double concentrated—prepared as above) 40 mg (1M in H2O) there was added 1 mL MTBE and the solution was degassed. 47 mg Pd/C (5%) was added followed by 1 drop of HCOOH. The reaction was heated to 80° C. for 1 hour and the reaction was cooled and filtered to give 10 mg of a product. The mixture was analyzed using GPC.

### Example 3

To membrane-filtrated lignin (double concentrated—prepared as above) (2 ml, 1M in H2O) 1,2-epoxybutane (2 ml) was added as well as 0.18 g of sodium hydroxide. The reaction was stirred and heated at 60° C. for 18 h. A sample was taken and neutralized with HCl for analyses on GPC. After allowing the reaction mixture to cool to room temperature light gas oil and 1 drop of concentrated hydrochloric acid (HCl) acid was added. After a certain time the lignin precipitates rom the aqueous phase.

### Example 4

To the concentrate of the second membrane filtration (2 ml) dodecyl succinic anhydride (ASA) (2 ml) was added drop-wise. The reaction was stirred and heated at 80° C. for 18 h. A sample was taken and neutralized with HCl for analyses on GPC. After allowing the reaction mixture to cool to room temperature light gas oil was added and the mixture was neutralized with concentrated HCl acid. Upon standing the lignin separates out from the aqueous phase.

### Example 5

To the concentrate of the second membrane filtration (2 ml) 4-heptadecylidene-3-hexadecyl-oxetan-2-one (AKD) (2 ml) was added drop-wise. The reaction was stirred and at R.T. for 24 h. A sample was taken and neutralized with HCl for analyses on GPC. After allowing the reaction mixture to cool to room temperature light gas oil was added and the mixture was neutralized with conc. HCl acid. Upon standing the lignin separates out from the aqueous phase.

### Example 6

In an experimental set-up a batch of 100 liters liquid (aqueous) with 5% lignin and 10% inorganics is run through a UF membrane with a cutoff at 15 kDa.

After the first filtration step 80 liters of permeate with 5% lignin and 10% inorganics and 20 liters with large fragments, i.e. water and 5% lignin and 10% inorganics are obtained.

The permeate from the first step (i.e. a fraction <15 kDa) is then fed to a second membrane filtration unit and after the second filtration 70 liters permeate with 10% inorganics and some lignin, and 10 liters concentrate with 20-40% lignin and 10% inorganics (thus, the concentration of small fragments is not changed) are obtained.

The concentrate (10 liters) is diluted with 10 liters of water (i.e. 20 liters total volume) and subjected to a third filtration. After the dilution the liquid is again subjected to MF as above and 10 liters concentrate having 20-40% lignin (i.e. the same concentration as in the previous step) but now the concentration of inorganics is reduced to 3-5%.

### Example 7

The same set-up as in Example 6 is used and the first step is performed in the same way.

However, dilution with 80 liters is performed already before the second filtration, i.e. 80 liters of permeate from the first filtration is diluted with 80 liters of water. This is a possible mode of operation within the scope of the invention, but would not bring about the same effect as if dilution is performed after the second filtration. In particular the amount of water required is much larger.

### Example 8

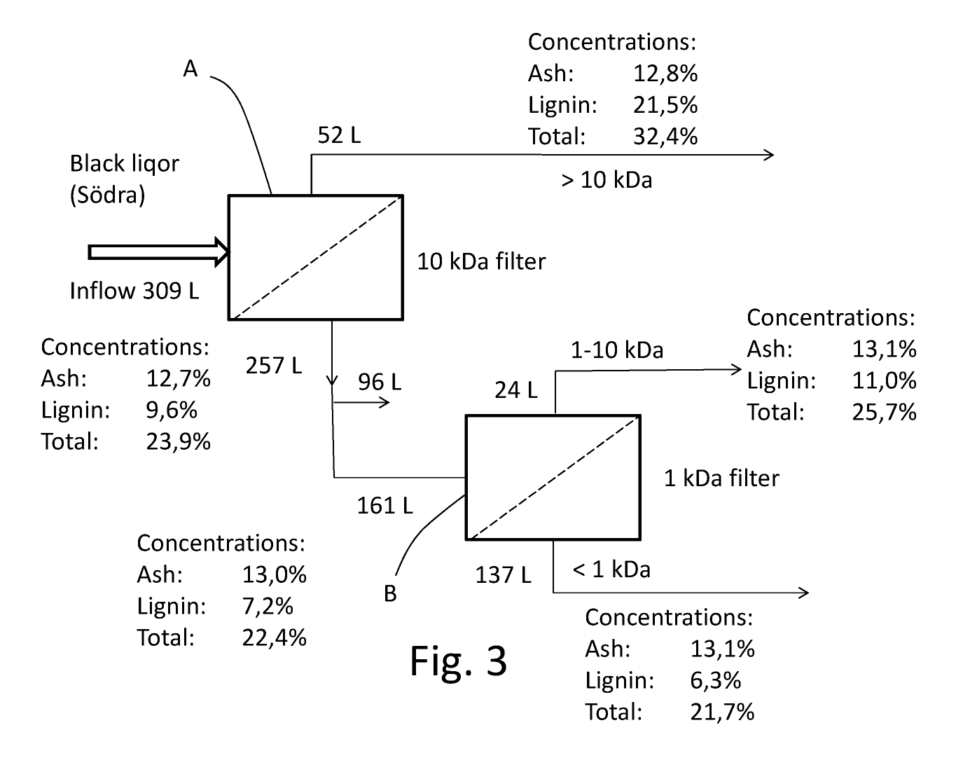

In FIG. 3 an actual test run according to the invention is illustrated. It uses the set-up according to FIG. 2, but details in the process such as dilution and re-circulations are not shown. Instead the amounts of liquid flowing through the system are shown as well as the composition of the various concentrates (retentates) and permeates.

The test set-up comprises two stages of ceramic membrane filters from Atech Innovations Gmbh. In the first stage the nominal cut-off is 10 kDa and in the second stage the cut-off is 1 kDa. In the membrane module used there is enough space for a 1200 mm long membrane with an outer diameter of 41 mm. Both membranes (Stage A and B) are designed to have 37 channels with an inner diameter of 3.8 mm per channel, which results in a membrane surface area of 0.53 m² per membrane.

The raw material is black liquor from Södra Cell Mörrums Bruk, which has a reported dry matter contents of 50%. This being too high, the liquor is diluted to a dry matter content of 25%, namely 250 liters liquor as delivered is diluted with 250 liters de-ionized water making up a total of 500 liters. This diluted material is used as the starting raw material for the test run.

In the test, 309 liters of the diluted material are fed into the first filtration stage A.

Due to fouling of the membranes the first stage (A) in this test run has to be split in two runs with a membrane wash between stages, but FIG. 3 illustrates the overall process, i.e. the two runs in stage (A) are shown as one single run.

The two runs result in 21+31 liters=52 liters concentrate and 129+128=257 liters permeate, which can be used for the second stage (B).

However, only 161 liters of the permeate from stage A is used as feed to stage B. The difference, 96 liters, is passed on for analysis purposes. In production mode this sampling from the permeate would not be required.

In the second stage (B) the feed is split in a concentrate of 24 liters and a permeate of 137 liters. The concentrate contains 11% lignin, which means that about 17% of the lignin in the feed to stage (A) is collected in the retentate fraction from stage (B).

1. A method for treating a liquid lignin composition to obtain a lignin fraction having a desired molecular weight distribution, comprising the steps of:
subjecting a liquid lignin containing composition, e.g. black liquor, to a first membrane filtration with a first filter cut-off adapted to separate species in said liquid lignin containing composition in fractions thereby providing a permeate and a retentate having respective molecular weight distributions defined by said cut-off;
subjecting either the retentate or the permeate from the first membrane filtration to at least one further membrane filtration step with a second filter cut-off different from said first filter cut-off to provide a retentate (concentrate) and a permeate having respective molecular weight distributions defined by both the cut-off in the first filter and the cut-off in said second filter; wherein
recirculating the retentate from at least one of the further filtration steps to increase the concentration to a desired amount of lignin;
diluting a desired lignin containing fraction at some point downstream of the first filtration unit; and
collecting a desired lignin containing fraction, i.e. a retentate (concentrate) or a permeate from the further membrane filtration for further processing.

2. A method for treating a liquid lignin composition to obtain a lignin fraction having a desired molecular weight distribution, comprising the steps of:
subjecting the liquid lignin composition to a first membrane filtration with a first filter cut-off adapted to separate out species having a molecular weight over a predetermined value thereby providing a permeate with a molecular weight distribution having an upper limit defined by said cut-off;
subjecting the permeate from the first membrane filtration to at least one further membrane filtration step with a second filter cut-off which is lower than the cut-off of the first filter to provide a retentate (concentrate) with a molecular weight distribution having an upper limit defined by the cut-off in the first filter and a lower limit defined by the cut-off in said second filter; wherein
recirculating the retentate from at least one of the further filtration steps to increase the concentration to a desired amount of lignin;
diluting a desired lignin containing fraction at some point downstream of the first filtration unit; and
collecting a desired lignin containing fraction, i.e. a retentate (concentrate) or a permeate from the further membrane filtration for further processing.

3. A method for treating a liquid lignin composition to obtain a lignin fraction having a desired molecular weight distribution, comprising the steps of:
subjecting the liquid lignin composition to a first ultrafiltration with a first filter cut-off adapted to separate out species having a molecular weight below a predetermined value thereby providing a retentate with a molecular weight distribution having a lower limit defined by said first cut-off;
subjecting the retentate from the first membrane filtration to at least one further membrane filtration step with a second filter cut-off which is higher than the cut-off of the first filter to provide a permeate with a molecular weight distribution having a lower limit defined by the cut-off in the first filter and an upper limit defined by the cut-off in said further filter; wherein
recirculating the retentate from at least one of the further filtration steps to increase the concentration to a desired amount of lignin;
diluting a desired lignin containing fraction at some point downstream of the first filtration unit; and
collecting a desired lignin containing fraction, i.e. a retentate (concentrate) or a permeate from the further membrane filtration for further processing.

4. The method according to claim 1, wherein the cut-off in the first step is at least 5 kDa, preferably at least 10 kDa, suitably 15 kDa, optionally 20 kDa.

5. The method according to claim 1, wherein the cut-off in the second step is 3 kDa or lower, but not lower than 0.2 Da, preferably about 1 kDa.

6. The method according to claim 1, wherein the cut-off in the first step is 3 kDa or lower, but not lower than 0.2 Da, preferably about 1 kDa.

7. The method according to claim 1, wherein the cut-off in the second step is at least 5 kDa, preferably at least 10 kDa, suitably 15 kDa, optionally 20 kDa.

8. The method according to claim 1, wherein the cut-off in a third step is 3 kDa or lower, but not lower than 0.5 Da, preferably 1 kDa.

9. The method according to claim 1, wherein the retentate in a third step is recirculated and wherein the dilution is performed on the recirculating retentate.

10. The method according to claim 1, wherein the dilution is performed on the retentate from the second step before feeding into the third unit.

11. The method according to claim 1 wherein the pH of the collected lignin containing concentrate is lowered so that the lignin is precipitated and the precipitated lignin is isolated.

12. The method according to claim 1 wherein the pH of the collected lignin permeate is lowered in order to precipitate the lignin.

13. The method according to claim 1, wherein the dilution is about 1:1 (retentate:solvent) such as to provide a reduction of the lignin concentration to about 50%.

14. The method according to claim 1, wherein the lignin of the retentate of the second step, before or after recirculation, is reduced or functionalized.

15. The method according to claim 10 wherein the lignin of the retentate of the second step is reduced and the collected lignin containing retentate of the third step is functionalized.

16. The method according to claim 1 wherein the liquid lignin composition is black liquor.
